(19) United States
(12) Patent Application Publication
(10) Pub. No.: US 2012/0228518 A1
(43) Pub. Date: Sep. 13, 2012

(54) FLUORESCENCE CORRELATION SPECTROSCOPY SYSTEM FOR ANALYZING PARTICLES IN A MEDIUM

(75) Inventors: Herve Rigneault, Allauch (FR); Jerome Wenger, Vitrolles (FR); Heykel Aouani, Marseille (FR); Patrick Ferrand, Marseille (FR); Neso Sojic, Cestas (FR); Frederique Deiss, Strasbourg (FR)

(73) Assignee: CENTRE NATIONAL DE LA RECHERCHE SCIENTIFIQUE - CNRS, PARIS CEDEX 16 (FR)

(21) Appl. No.: 13/393,445

(22) PCT Filed: Aug. 24, 2010
(86) PCT No.: PCT/FR2010/051762

§ 371 Date: Apr. 30, 2012

(30) Foreign Application Priority Data
Sep. 2, 2009 (FR) 0955987

(51) Int. Cl. G01N 21/64

(52) U.S. Cl. 250/458.1; 250/206

(57) ABSTRACT

The present invention relates to a fluorescence correlation spectroscopy system (1) for analyzing particles in a medium (2), including a means (3) for detecting the light (7) emitted by the particles in the medium (2), said means (3) being coupled to a waveguide (4), for which purpose the end piece of the guide (4) comprises a means (4b; 5) for confining the light (7) injected into the guide (4).

### CROSS-REFERENCE TO RELATED APPLICATION

This Application is a National Stage Entry of International Application No. PCT/FR2010/051762, having an international filing date of Aug. 24, 2010; which claims priority to French Application No. 0955987, filed Sep. 2, 2009; the disclosure of each of which is hereby incorporated in its entirety by reference.

### TECHNICAL FIELD

The present invention relates to the field of fluorescence correlation spectroscopy systems for detecting and analyzing solution luminescent or optically diffusing molecules, these molecules can be fluorescent under the effect of an exciter light.

### PRIOR ART

In conventional optically diffusing luminescent molecules detection modes, it is known to use confocal microscopy systems. In the case of analyzing fluorescent particles, these systems comprise a laser source emitting an excitation laser beam, a dichroic mirror, a microscope with a highly enlarging lens and high numerical aperture, an optical conjugation device, a spatial filter and finally a detector. The excitation laser beam becomes convergent through the microscope lens in a focal point at the particles that are required to be analyzed, these particles being in solution on an optically passive substrate (a glass plate). The focused laser light beam is absorbed by the particles, and then reemitted at a wavelength higher than that of the laser beam to then be directed on the detector via the optical conjugation device.

The spatial filter makes it possible to delimit an analysis volume and thus, obtain a spatial resolution lower than the micrometer. To this end, it comprises a diaphragm arranged upstream of the detector, in a plane conjugated to the focal plane of the microscope lens. In this regard, only the photons located in a volume around the focal point of the excitation laser beam participate in the formation of the image at the detector.

In order to obtain an important amount of information about solution fluorescent particles, a correlator is connected to the detector in order to analyze the temporal fluctuations of the fluorescent light emitted by the analysis volume, such as to achieve a detection by fluorescence correlation spectroscopy (FCS). These temporal fluctuations are directly related to the diffusion of fluorophores through the analysis volume. Over short timescales, the autocorrelation function of the detected light intensity makes it possible to access to the photophysical parameters of the transmitters as well as a mean number of detected molecules. Over long timescales, this function shows the mean residence time—diffusion time—of the molecules and their diffusion mode through the analysis volume.

An example of microscopy system can be found in the patent document US 2007/0291254 A1, which describes a portable instrument of fluorescence correlation spectroscopy, also called fluorescence correlation. This instrument further comprises an exciter source, several focal means arranged to focus the light emitted by the exciter source in the direction of a sample of particles, a detector arranged to receive the light emitted by a sample of particles excited by the exciter source, and finally a correlator for processing the data transmitted by the detector with a view to providing autocorrelation data, cross-correlation data or a combination thereof.

Due to the use of a microscope lens with high numerical aperture (typically ON=1.2 to 1.5) and of a passive substrate, these confocal microscopy systems exhibit several drawbacks, among which a complexity, a high production cost and significant encumbrance. The instrument described in document US 2007/0291254 A1, although described as a portable instrument, comprises a microscope lens and a passive substrate, providing it with a compactness that remains unsatisfactory, as well as an incapacity to function in situ in endoscopy mode.

Though, for certain industrial applications for analyzing solutions containing luminescent or optically diffusing molecules, it is preferable to have a spectroscopy system which is at the same time simple to manufacture, while being compact and portable. Particularly, it is required to have a portable probe that is able to be directly immersed in the solution to analyze, without the need for prior extraction and positioning on a passive substrate.

A currently existing solution is based on the use of a waveguide, and more particularly on a monomode optical fiber. Thus, a spectroscopy system for analyzing particles in a medium is achieved, comprising means for detecting the light emitted by the particles in the medium, this means being coupled to a waveguide.

Such a solution is described in patent document EP 0 697 590 A1. In this document, in a first alternative, light is emitted from a stimulating light source, via a first optical fiber to a coupler then, via a second optical fiber, to the sample to analyze. The fluorescence light emitted by the particles of the sample is transmitted, via the second optical fiber, to the coupler, then, via a third optical fiber, to the detector. According to a second alternative, the light emitted by the source is carried on the sample via a first optical fiber and the fluorescence light emitted by the particles of the sample is carried on the detector via a second optical fiber. In each case, the end of the fibers facing the sample is oriented such that the light emitted by the source is carried in a precise manner on the sample volume that needs to be analyzed.

This solution may be transposed to the spectroscopy of fluorescent or optically diffusing particles, for which it is possible to exclude exciter light sources, thus resorting to use only one optical fiber coupled on one side to the detector and on the other side to the sample volume to analyze.

This solution makes it possible to have a portable probe, constituted by the end piece of the waveguide that is not coupled to the detector. This probe may directly be immersed in the solution to analyze, thus avoiding the use of a passive substrate.

The drawback of this solution however resides in the low detection efficiency that a spectroscopy system may reach using a waveguide, thus preventing the detection of individual molecules and consequently limits the detection threshold to particles of a diameter typically higher than 25 nanometers.

### OBJECT OF THE INVENTION

Based on a fluorescence correlation spectroscopy system for analyzing particles in a medium, including means for detecting the light emitted by the particles in the medium, this means being coupled to a waveguide, the purpose of the present invention is to make it a system which may exhibit a simplicity and low production cost, constitute a portable spectroscopy probe and offer single-molecule sensitivity.

To this end, the invention relates to a fluorescence correlation spectroscopy system for analyzing particles in a medium, comprising means for detecting the light emitted by the particles in the medium. The detection means is able to detect the light emitted by fluorescence by the particles in the medium and is coupled to means for processing the signal which it provides. This processing means is configured to analyze the temporal evolution of the detected signal. The detection means is coupled to a waveguide. The guide comprises at its end piece means for confining the light injected into the guide.

This solution makes it possible to enhance the reception of light emitted by the particles, whether this emission is due to the luminescent or the optical diffusing properties of the particles, or their fluorescence under the effect of an exciter light. Thus, it is only possible to observe a small observation volume with the detector in the medium to analyze, thus making it possible to obtain a much lower resolution to that obtained with the spectroscopy systems with the related art waveguides, thus making it possible to resolve down to the dimension of a unique molecule with a high signal to noise ratio.

Furthermore, the combination of the confinement means and of the waveguide, coupled on the one hand to the detector and on the other hand to the observation volume in the medium to analyze, makes it possible to simplify the system, since the use of a microscope lens and a passive substrate becomes useless. The manufacture of such a system is thus simplified for a lower cost.

According to other applications where the portability is of lesser importance, it will nevertheless be always possible to achieve a confocal microscope spectroscopy system, whereof the microscope lens is coupled by an end piece to a waveguide, itself coupled by its other end piece to the observation volume. This type of system thus exhibits a great analysis precision while having a portable probe due to the fact that the end piece of the waveguide may be directly immersed in the solution containing the particles.

Finally, this combination makes it possible to have a portable probe, constituted by the waveguide provided at its end piece with confinement means. This probe may be directly immersed in a solution to be analyzed, the position of the observation volume thus being dependent on the position of the guide end piece. This probe, connected to the rest of the system which may not be portable, offers an ease of use and is perfectly suitable with applications such as endoscopy, based on in situ measurements.

According to various particular embodiments:
the detection means comprises a photodiode, and
the waveguide comprises an optical fiber.

The confinement means may be made in different ways, particularly:
it comprises a microstructuration of the end piece of the guide,
it comprises a microsphere, or
it comprises a combination of the latter.

Preferably, the confinement means exhibits a strictly positive focal length and a refractive index higher than that of the medium.

In order to obtain an observation volume of symmetrical shape around the waveguide axis, the confinement means is advantageously provided such that it is substantially centered on the core of the guide. In this case, the end piece of the guide may be arranged such as to automatically center the confinement means at its level.

In order to confine all the light which crosses the waveguide, the confinement means is advantageously provided such that it exhibits a section substantially equal to that of the guide core.

In the case where the detection means is coupled to several waveguides, each of these guides preferably comprises a confinement means at its end piece.

In the case where a waveguide comprises several cores, each preferably comprises a confinement means at its end piece.

The fluorescence correlation spectroscopy system for analyzing particles in a medium further comprises an illumination means able to emit an excitation light beam, the detection means being able to detect the light emitted by fluorescence by the particles in the medium under the effect of the excitation light beam and being coupled to a signal processing means that it provides.

In the above case, the processing means correspond to a correlator connected to the detector in order to analyze the temporal fluctuations of the light emitted by the analysis volume, by fluorescence, such as to achieve a detection by fluorescence correlation spectroscopy.

The illumination means may be, according to different alternatives:
a laser, or
a mercury lamp provided with a filter.

Preferably, the illumination means is coupled to a waveguide thus making it possible to delocalize the excitation source. This new waveguide may also be provided at its end piece with light confinement means which crosses this guide. The excitation light beam is thus also confined in a small dimension excitation volume. The illumination means is thus arranged such that the excitation volume corresponds to the observation volume. Thus, a perfectly concentrated and localized exciter power is ensured and thereby, is even higher.

In this last case where the illumination means is coupled to a waveguide, it may be advantageously provided that the detection and illumination means are coupled to the same waveguide via a coupler, thus making it possible to perfectly superimpose the excitation volume and the observation volume.

The invention also relates to a fluorescence correlation spectroscopy system for analyzing particles in a medium comprising at least two illumination means able to emit an excitation light beam at different excitation wavelengths, and at least two means for detecting the light emitted by fluorescence by the particles in the medium due to the excitation light beams with different excitation wavelengths. Each detection means is coupled to a waveguide. The detection means is coupled to means for processing the signal which it provides. The processing means is configured to analyze the signal temporal evolution. The guides coupled to the detection means comprise at their end pieces, means for confining the light injected into the guides.

The invention lastly relates to a fluorescence correlation spectroscopy system for analyzing particles in a medium comprising at least two spectroscopy systems according to any one of the aforementioned embodiments, the illumination means of these systems being able to emit excitation light means at a same excitation wavelength, the detection means being able to detect the light emitted by fluorescence by the particles in the medium and being coupled to a same signal processing means which it provides.

The processing means here also corresponds to a correlator. In order to facilitate reading the patent, the skilled person will here only include guides coupled to each other, such as the guides connected with the detection means, are considered as having for end piece that of the guide resulting from different couplings, thus, corresponding in the case study to the end piece immersed in the medium to be analyzed.

### BRIEF DESCRIPTION OF THE DRAWINGS

The invention will be better understood upon reading the detailed description of a non limitative embodiment, accompanied with figs. respectively representing:

FIG. 1, a diagram of a spectroscopy system for analyzing particles in a medium according to a first embodiment of the invention,

FIGS. 2 and 2A, a diagram of the end piece of the waveguide immersed in the medium to analyze according to this first embodiment,

FIG. 3, diagrams of different alternative embodiments of the means for confining the light injected into the waveguide,

FIG. 4, a diagram of a fluorescence cross-correlation spectroscopy system according to a second embodiment of the invention,

FIG. 5, a diagram of a fluorescence cross-correlation spectroscopy system according to a third embodiment of the invention, and

FIG. 6, a diagram of an implementation example of a fluorescence correlation spectroscopy system with portable probe.

For more clarity, the identical or similar members are marked by identical reference signs on all the figs.

### DETAILED SUMMARY OF PARTICULAR EMBODIMENTS

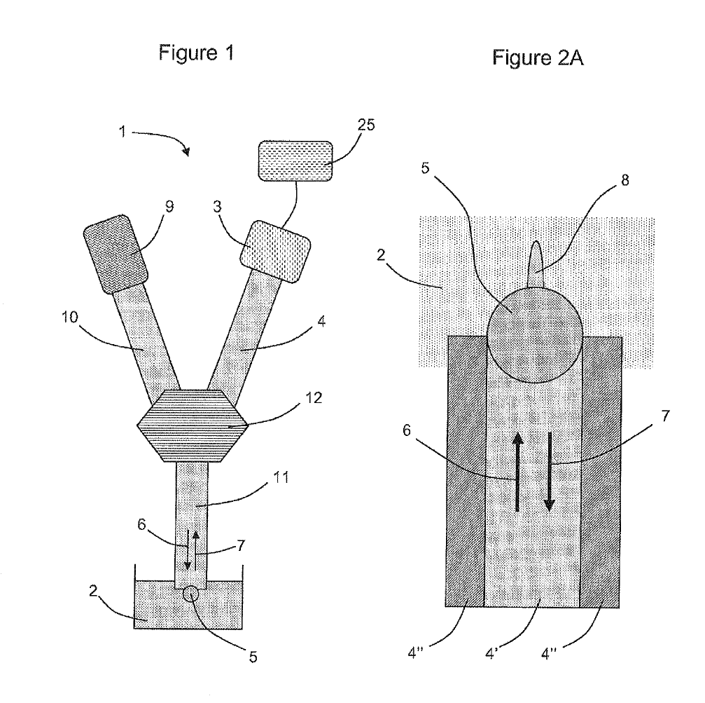

FIG. 1 represents a diagram of a spectroscopy system for analyzing particles in a medium according to a first embodiment of the invention.

The purpose of the spectroscopy system 1 is to analyze a sample in a medium 2. This sample may be a liquid, gaseous medium or a biological object containing particles to analyze. The particles to analyze may be molecules or molecular assemblies, such as for example molecular complexes, nanocrystals or nanobeads.

Therefore, the system 1 comprises a detection means 3, a waveguide 4 and a confinement means 5.

The detection means 3 makes it possible to measure the intensity of the light flux 7 emitted by the sample 2 at an observation volume and collected by the spectroscopy system 1. In a particular embodiment, this means 3 comprises photodetectors with electron amplifiers, advantageously photodiodes operating in avalanche regime—APD. These photodetectors may also be photomultipliers. According to other embodiments, this detection means 3 comprises optically amplified photodetectors, such as cooled CCD or CMOS cameras, for example with liquid air or Peltier elements.

The detection is carried out according to a temporal regime where the detector integrates the signal over short temporal ranges with respect to the process to analyze. The information is thus, given by analyzing this temporal trace.

The system 1 further comprises a coupler 12 and a third waveguide 11. The fiber coupler carries out the coupling of the fibers 4 and 10, respectively linked to the detection 3 and illumination 9 means. The resulting light is transmitted to the fiber 11 which is provided at its end piece with a confinement means 5. The exciter light 6 is thus concentrated in a small excitation volume. Following the excitation of particles in the excitation volume, the latter in return emit the light 7 by fluorescence. Owing to the confinement means 5, this light 7 crosses the fiber 11 then the fiber 4 via the coupler 12, before reaching the detection means 3. Due to the arrangement of a fiber 11 whereby passes the excitation 6 light and fluorescence 7 fluxes as well as the arrangement of a unique confinement means 5, the excitation and observation 8 volumes are identical, thus, making it possible to directly concentrate the excitation flux at the observation volume and hence, optimize particle stimulation.

Furthermore, here the system 1 comprises a signal processing means 25, connected to the detection means 3. This means 25 advantageously comprises a counter and a correlator which make it possible to numerically process the received data. Particularly, the counter records the received fluorescent light intensity value and the correlator carries out the temporal analysis of the received fluorescent light intensity fluctuations. This analysis may be carried out over short and long timescales such as to obtain additional information about the particles in solution in the medium 2. Over short timescales, the fluorescence autocorrelation function makes it possible to have access to the photophysical parameters of the transmitters as well as the mean number of detected molecules. Over long timescales, this function gives information about the mean residence time of the molecules and their diffusion mode through the observation volume.

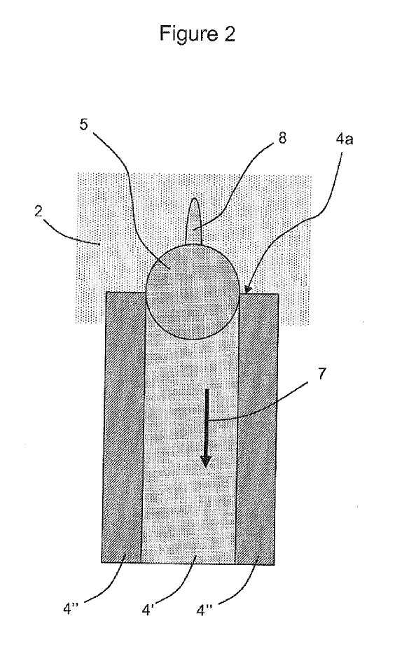

The waveguide 4 is constituted of a unique monomode step index optical fiber. It is coupled, by its end piece 4a, to the observation volume in the medium 2 and, by its other end piece 4b, to the detection means 3. As illustrated on FIG. 2, it classically comprises a core 4′ surrounded with a cladding 4″, whereof the refractive indexes are determined such that the light beam 7 emitted by the sample to analyze can propagate within the fiber. According to other embodiments, the used optical fiber may be multimode or with a graded index.

The confinement means 5 exhibits a strictly positive focal length and a refractive index higher than the refractive index of the core 4′ of the guide 4. In these conditions and as illustrated in FIG. 2, the particles located in the observation volume 8 emit light, by fluorescence following a prior light excitation, which crosses the confinement means 5. This volume 8 is located in a boundary area of the confinement means 5. This volume is rendered narrow as its focal length is strictly positive and its refractive index is higher than that of the core 4′ of the guide 4. The particles that are not located in the observation volume 8 will emit light which cannot be directed to inside the core 4′, due to the arrangement of the confinement means 5. The light injected into the waveguide 4 is thus limited to that emitted by the particles in the observation volume 8.

This confinement means 5 thus makes it possible to isolate a certain number of particles located in a very small observation volume 8. Particularly, this volume 8 may reach half the wavelength in longitudinal dimension and the wavelength in axial dimension, i.e., dimensions less than the diffraction limit, thus making it possible to reach an analysis volume less than the tenth of femtoliter.

Moreover, the refractive index being higher than that of the core 4′, the light beam 7 collected then detected is all the more important. The confinement means 5 thus constitutes a microstructured interface between the medium 2 and the waveguide 4, such as to reduce the dimensions of the observation volume corresponding to the portion of light flux effectively collected.

This means 5 exhibits micrometric dimensions, of the order of 1 to 5 micrometers, and a high refractive index, of the order of 1.4 to 1.6.

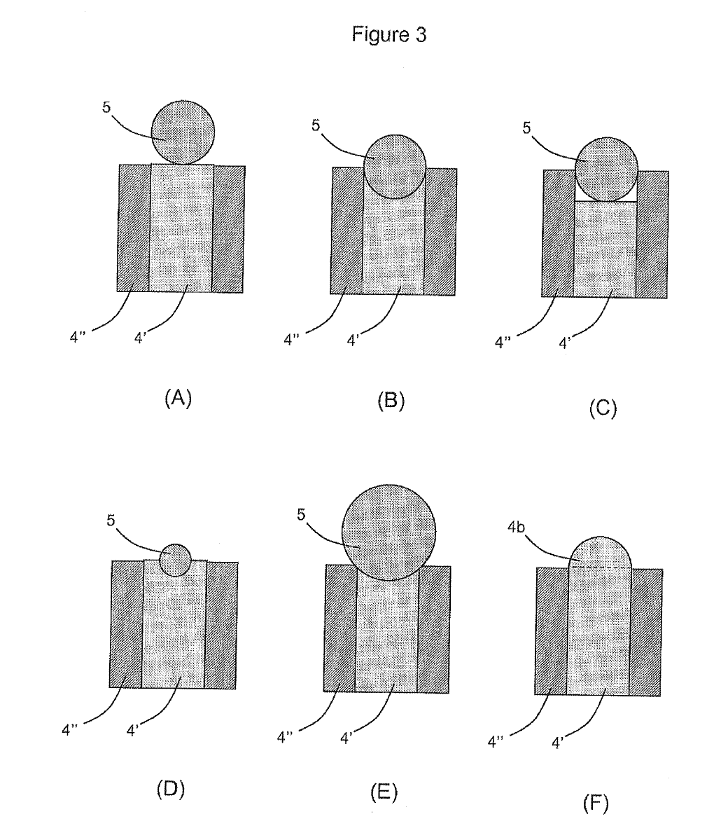

The confinement means 5, as a microstructured interface, may be made according to various alternatives, such as illustrated by FIGS. 3A to 3F.

In the case of FIGS. 3A to 3E, the confinement means 5 is a microbead of spherical shape, rendered not integral with the core 4′, of the guide 4.

The microbeads or microspheres 5 of FIGS. 3A to 3C exhibit a diameter substantially equal to the core 4′. The microbead of FIG. 3A is simply arranged on the end piece of the fiber 4 by dispersion of dielectric microbeads. Those of FIGS. 3B and 3C are also deposited by dispersing dielectric microbeads, but after a prior step of chemical attack of the end piece of the fiber such as to form a cistern serving as receptacle for the microbeads, thus making it possible to correctly center the bead with respect to the axis of fiber 4. This type of embodiment has the advantage of being simple to implement and to be able to be spread on a large scale.

Although the preferred dimension of the means of a microbead is such that its diameter is substantially equal to that of the core 4′, it may also be considered to make it less than the diameter of the core 4′ (FIG. 3D) or higher (FIG. 3E). In each case, it remains preferable that the microbead or microsphere is centered according to the guide axis 4.

In the case of FIG. 3F, the confinement means 4b is a microstructuration in the shape of a spherical cup, consequently integral with the core 4′ of the guide 4 since it forms a portion of it. This type of microstructuration may be obtained by classical embodiment methods of a microtip or a microstructure at the end of an optical fiber.

Here, the skilled person will note that it is possible to combine the above alternatives in order to achieve a hybrid confinement means, particularly superposing means integral with the core (obtained by core structuration) and means not integral with it (microbeads), or by superposing several microbeads.

The skilled person will also note that the shape of the confinement means is not necessarily spherical and may be in particular elliptic or cylindrical. Other forms are to be considered in so far as they make it possible to confine the light 7 into a small observation volume 8 for injecting it into the guide 4.

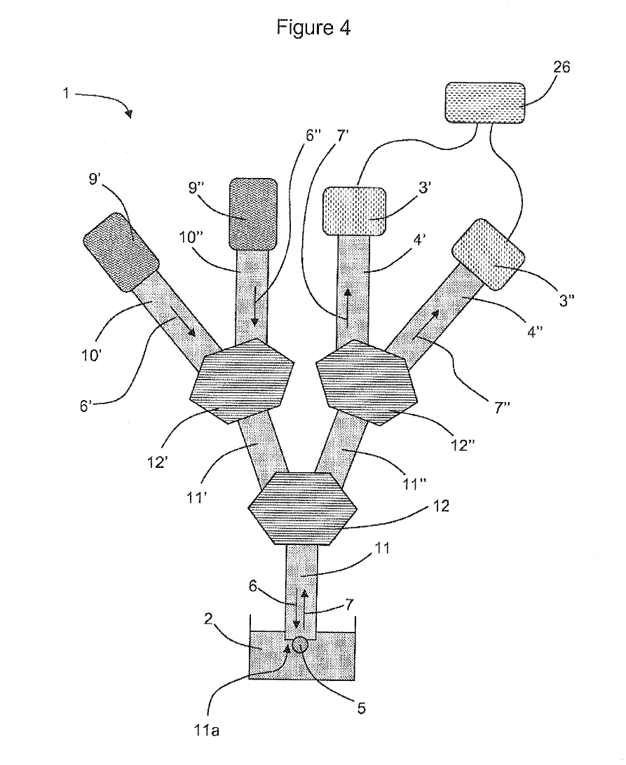

In the second embodiment, illustrated by FIG. 4, the system 1 is arranged to achieve fluorescence cross-correlation spectroscopy. For this reason, it comprises two illumination means 9′ and 9″, respectively emitting, via waveguides 10′ and 10″, excitation light beams 6′ and 6″, at different wavelengths λ′ and λ″. These beams 6′ and 6″ are mixed at a coupler 12′ to generate an excitation light beam 6, comprising two wavelengths, which is then injected into a guide 11′, then into a guide 11 via another coupler 12.

This beam 6 excites the particles of the medium 2 located in an excitation volume delimited by the confinement means 5.

The excited particles in this volume thus, emit a light beam 7 in response, by fluorescence, which is injected into the guide 11 thanks to the confinement means 5. This fluorescent light is transmitted to the guide 11′ via the coupler 12, then is spectrally separated at the coupler 12″, into two beams 7′ and 7″ respectively at wavelengths λ′″ and λ″″, function of excitation wavelengths λ′ and λ″.

These two beams 7′ and 7″ are thus carried to the detection means 3′ and 3″ by means of fibers 4′ and 4″. A processing means 26 is connected to these two detection means 3′ and 3″ to record the signals generated by the two detectors and analyze them under cross-correlation. This type of measurement thus, makes it possible to access other parameters relating to the particles to analyze.

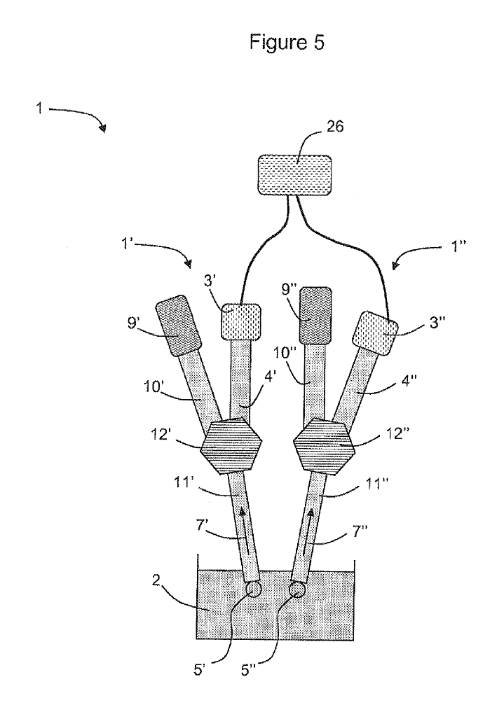

In the third embodiment, illustrated by FIG. 5, the system is arranged to achieve fluorescence cross-correlation spectroscopy.

For this, it comprises two spectroscopy systems (or sub-systems) 1′ and 1″ identical to the embodiment of FIG. 1. These sub-systems respectively comprise an illumination means 9′ (or 9″), waveguides 4′ 10′ and 11′ (or 4″, 10″ and 11″), a coupler 12′ (or 12″), a detection means 3′ (or 3″) and a confinement means 5′ (or 5″).

The illumination means 9′ and 9″ are able to emit excitation light beams at a same excitation wavelength, via the waveguides 10′ and 11′ (10″ and 11″). The detection means 3′ and 3″ are able to detect the light 7′ and 7″ emitted by fluorescence by the particles in the medium 2, and are also coupled to a same means 26 for processing the signal that they provide. The processing treatment 26 thus, operates the cross-correlation of the data transmitted by the two detectors 3′ and 3″.

The two end pieces 11′ and 11″—as well as the confinement means 5′ and 5″ which are deposited thereto—are arranged such as to observe different areas of the space, i.e. two different observation volumes but separated at a distance typically of the order of the width of the guides 11′ and 11″, namely between around 2 and 3 micrometers. In this way, it is possible to measure the transit velocities of the particles between one and the other guide end pieces, hence, between one and the other of the spectroscopy sub-systems 1′ and 1″.

The two last aforementioned embodiments both make it possible to achieve fluorescence cross-correlation spectroscopy, but in different manners. In the second embodiment, only one waveguide 11 is used with a confinement means and two different excitation wavelengths. A set of spectral data is thus correlated in order to obtain certain information about the particles in the medium, complementary to those provided by auto-correlation. In the third embodiment, two waveguides 11′ and 11″ are used with a confinement means and one single excitation wavelength. A set of spectral data is thus correlated in order to obtain other information about the particles, particularly the fluxes and transit velocities.

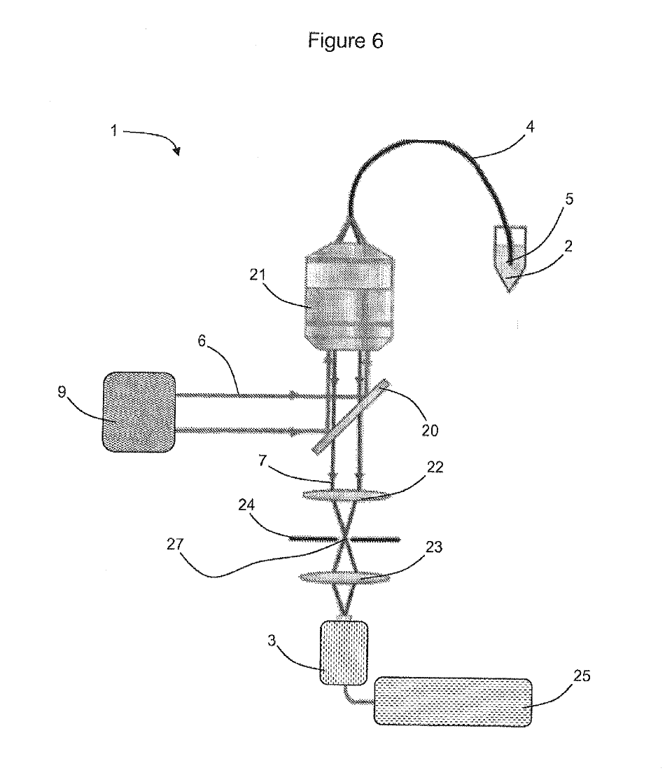

Finally an example for implementing a fluorescence correlation spectroscopy system with portable probe is described, combining the present invention and a confocal microscopy system, with reference to FIG. 6.

This spectroscopy system always comprises, as described in other embodiments of the invention, an illumination means 9, an optical fiber 4, a confinement means 5, a detection means 3 and a processing means 25. The end piece of the fiber 4 at which the confinement means 5 is, constitutes a portable spectroscopy probe able to be immersed in the medium 2 to analyze.

The fiber 4 is coupled by its other end piece with a microscope lens 21 which makes it possible to inject in an optimal manner the excitation light flux generated by the light probe 9.

In order for the probe to be coupled to the illumination means 9 as well as to the detection means 3, the system comprises a dichroic separator 20, whereof the cutting wavelength is located between the wavelength λ1 of the excitation light flux 6 and the wavelength λ2 (higher than λ1) of the light flux 7 emitted in response by the fluorescent particles. This way, the excitation flux 6 is reflected on the separator, whereas the return flux 7 is transmitted through it. This separator 21 is advantageously exhibited under the form of a dichroic filter arranged at 45° with respect to the illumination means 9.

The rest of the microscopy device comprises two lenses 22 and 23, as well as a diaphragm 24 making it possible to achieve a spatial filtering. The dimension of the diaphragm 24 is advantageously adjustable. It is arranged according to the direction of the axis of the return light beam 7. It is arranged at the focal point 27 of the lens 22. Thus, it makes it possible to select a detection volume—or spatial filtering volume—around the focal point 27 of the lens 22, since light beams not coming from this spatial filtering volume do not cross the aperture 24. The dimensions of the detection area are all the more short since the aperture ones are too 24. The assembly constituted of members 22, 23 and 24 thus, forms a pinhole having a variable aperture 24 placed in an intermediary image plane such that the microscopy system conjugates the focal point 27 of the return beam 7 with the variable aperture 24 of the pinhole.

The skilled person may note that other means for spatially filtering the return beam 7 may be used, the system hence, no longer being a confocal microscopy. He may particularly use a hole in a metallic plate, an optical fiber, whereof the core diameter sets the useful aperture, or even the reduced dimension of the detection means.

The above-mentioned spectroscopy systems offer many applications in the field of biological tests in liquid medium, particularly for scientific research, medical tests, food industry analysis, the chemical and pharmaceutical industry and defense.

The previously described embodiments of the present invention are given by way of examples and are in no way limitative. It is obvious that the skilled person is able to achieve different alternatives of the invention within the framework of the patent.

1. A fluorescence correlation spectroscopy system for analyzing particles in a medium (2), including means (3) for detecting the light (7) emitted by the particles in the medium (2), the detection means (3) being able to detect the light (7) emitted by fluorescence by the particles in the medium (2) and being coupled to means for processing (25) the signal it provides, this processing means (25) being configured to carry out an analysis of the temporal evolutions of the detected signal, the means (3) being coupled to a waveguide (4), characterized in that the guide waveguide (4) comprises at its end piece (4a) means (4b; 5) for confining the light (7) injected into the waveguide (4).

2. The spectroscopy system according to claim 1, further comprising an illumination means (9) able to emit an excitation light beam (6), the detection means (3) being able to detect the light (7) emitted by fluorescence by the particles in the medium (2) under the effect of the excitation light beam (6).

3. The spectroscopy system according to claim 2, wherein the illumination means (9) is coupled to a another waveguide (10).

4. The spectroscopy system according to claim 3, wherein the detection (3) and illumination (9) means are coupled to a same waveguide (11) via a coupler (12).

5. The spectroscopy system according to claim 2, wherein the illumination means (9) is a laser.

6. The spectroscopy system according to claim 2, wherein the illumination means (9) is a mercury lamp provided with a filter.

7. The spectroscopy system (1) according to claim 1 wherein the confinement means (4b;5) comprises a microsphere (5).

8. The spectroscopy system (1) according to claim 1, wherein the waveguide (4) comprises an optical fiber.

9. The spectroscopy system (1) according to claim 1, wherein the confinement means (4b;5) comprises a microstructuration (4b) of the end piece (4a) of the guide waveguide (4).

10. The spectroscopy system (1) according to claim 1, wherein the confinement means (4b;5) exhibits a strictly positive focal length and a refractive index higher than that of the medium (2).

11. The spectroscopy system (1) according to claim 10, wherein the end piece (4a) of the guide (4) is arranged such as to automatically center the confinement means (4b;5) at its level.

12. The spectroscopy system (1) according to claim 1, wherein the confinement means (4b;5) exhibits a section substantially equal to that of a core (4′) of the waveguide.

13. The spectroscopy system (1) according to claim 1, wherein the detection means (3) is coupled to several waveguides, each comprising a confinement means at its end piece.

14. The fluorescence correlation spectroscopy system for analyzing particles in a medium (2), comprising at least two illumination means (9′, 9″) able to emit an excitation light beam (6′, 6″) at different excitation wavelengths (λ′, λ″), and at least two means (3′, 3″) for detecting the light (7′, 7″) emitted by fluorescence by the particles in the medium (2) due to the excitation light beams (6′,6″) with different excitation (λ′, λ″) wavelengths, each means (3′, 3″) being coupled to a waveguide (4′, 4″), the means (3,3″) being coupled to means (26) for processing the signal that they provide, this processing means (26) being configured to carry out an analysis of temporal evolutions of said signal, characterized in that the guides (11;11″;4′,4″) coupled to the detection means (3′, 3″) comprise at their end pieces (11a) means (4b;5) for confining the light (7′, 7″) injected into the guides (11;11″; 4′, 4″).

15. The fluorescence correlation spectroscopy system (1) for analyzing particles in a medium (2), characterized in that it comprises at least two spectroscopy systems (1′,1″) according to any one of claims 2 to 13, the illumination means (9′,9″) of the systems (1′,1″) being able to emit excitation light beams at a same excitation wavelength, the detection means (3′,3″) being able to detect the light (7′, 7″) emitted by fluorescence by the particles in the medium (2) and being coupled to a same means (26) for processing the signal that they provide.
